(19) United States
(12) Patent Application Publication
(10) Pub. No.: US 2007/0047761 A1
(43) Pub. Date: Mar. 1, 2007

(54) Methods Of Analyzing Human Facial Symmetry And Balance To Provide Beauty Advice

(76) Inventors: Elizabeth Ann Wasilunas, Walpole, MA (US); Linda A. Wolf, Loveland, OH (US); R. Eric Wolf, Loveland, OH (US); Michael S. Lowry, Medfield, MA (US)

Correspondence Address: SYMONICS, INC., 11621 SYMMES CREEK DRIVE, LOVELAND, OH, 45140, US

(21) Appl. No.: 11/423,442

(22) Filed: Jun. 10, 2006

Related U.S. Application Data
(60) Provisional application No. 60/595,155, filed on Jun. 10, 2005.

(51) Int. Cl. G06K 9/00

(52) U.S. Cl. 382/100

(57) ABSTRACT

A method of analyzing a person's facial features to assist in facial image makeover and hair styling comprising uploading a working image of the person onto a computer, determining horizontal balance data, determining spatial balance data, determining feature balance data, determining natural hair growth pattern data, determining color balance data, and providing beauty advice to enhance the appearance of a more symmetrical face is provided.

### CROSS REFERENCE TO RELATED APPLICATION

This application claims the benefit under 35 USC 119(e) to U.S. Application No. 60/595,155, filed Jun. 10, 2005 and incorporated herein by reference.

### FIELD OF THE INVENTION

The present invention relates to methods of analyzing a person's human facial symmetry and balance in order to provide beauty advice to the person regarding hair style, hair arrangement, hair color, skin tone, and eyewear in order to enhance the appearance of a more symmetrical face. These methods are particularly useful in providing an educational tool for salon clients and stylists.

### BACKGROUND OF THE INVENTION

Symmetry can be observed throughout nature, for example, in butterfly wings, the human body, a seashell, strands of DNA, mammals, and flowers. Throughout history men have imitated nature in architecture and art. The Greeks used mathematical models of symmetry to design the Greek Parthenon, calling it the Golden Section. Leonardo da Vinci referred to it as “Divine Proportion” in his painting of The Last Supper. In everyday lives, we look for balance and harmony in our gardens, in the arrangement of furniture in a room, in automobile design, and so on. This is because humans perceive symmetrical objects and arrangements to be more beautiful or pleasing than asymmetrical ones.

No human face is truly symmetrical. There are slight variations in the horizontal and vertical distribution of almost all facial features. For example, one ear is almost always higher than the other, one eyebrow is almost always shaped differently or rests higher on the face, or one side of the mouth may turn downward while the other side may turn upward.

Because of this slight asymmetry, selecting a hairstyle is often a dilemma for both the client and the stylist. Selecting a hairstyle based on a magazine photo, on face shape, or by trying on virtual hairstyles in a computer imaging program is misleading because all faces and face shapes can appear attractive or unattractive depending on how well the hairstyle complements or conflicts with the individual's facial symmetry.

Prior studies of facial attractiveness conducted by Rhodes and Zebrowitz suggest that faces that appear to be more symmetrical are perceived by others to be younger, healthier, more desirable and attractive. Rhodes, G., Zebrowitz, L. A., Facial Attractiveness: evolutionary, cognitive, and social perspectives, 3-5, 24-25, 200-201, 263 (2002). Studies conducted on infants during their first hours of life suggest that they respond to and hold their gaze longer on faces that are more symmetrical. Langlois, J. H. et al., Infant preferences for attractive faces: Rudiments of a stereotype?, Developmental Psychology, 23, 363-369 (1987).

U.S. Pat. No. 4,519,037, to Brodeur et al., issued May 21, 1985, describes a complex computer-assisted symmetrical analysis for hair stylists that requires at least 18 and as many as 23 different measurements or criteria to determine a subject's head and facial characteristics and provides software to analyze up to 94,000 different combinations affecting the appearance of the head, face, and body as a whole. The invention has not been accepted by the salon industry due to its complexity.

U.S. Pat. No. 6,000,407, to Galazin, issued Dec. 14, 1999, and the “Color Me Beautiful” method by Jackson (Jackson, C., Color Me Beautiful, ISBN 0874912814 (1984)) describe similar methods and kits of equipment to determine an individual's favorable personal colors for cosmetics and makeup. Galazin's method involves application of specific colored powders to the face in order to determine proper value and hue, which can be messy or difficult to obtain. Further, subjective judgment and extensive experience are required to effectively implement Jackson's so-called “four-season” method.

U.S. Pat. No. 4,823,285, to Blancato, issued Apr. 18, 1989, describes a method which uses a computer system to enable a person to see him or herself with one or more new hairstyles. Using this method, a person may like the appearance of one or more of the hairstyles but may not understand the reason a particular hairstyle looks better than another.

U.S. Pat. No. 4,909,632, to Simpson, issued Mar. 20, 1990, describes a method or draping technique whereby blue-based or yellow-based material is used to visually observe the compatibility to the skin pigment of the subject. The object is to provide a person with a simplified color chart and samples of a garment or articles to be worn that may match as closely as possible a color on the chart.

In daily interactions between stylists and clients, there often exist conflicting points of view about what a new hairstyle should be. Clients are frustrated when a hairstyle that looks good in a magazine or on someone else doesn't look the same way on them. As salon clients age, they are distressed when a long-worn hair style no longer receives compliments, or their hair color appears dull and less flattering as their skin tone lightens. Clients want to appear more attractive but don't know how. Stylists tend to stay with tried and safe styles that they personally prefer or feel confident delivering, usually styles that conform to beauty school basics based on face shape, or current hair cutting techniques learned at hair shows. They want to offer more but don't know how.

The present invention overcomes both the problems of complexity attached to these disclosed methods and further allows the stylist and the customer to “take the guesswork” out of choosing a correct hairstyle for any face. The invention combines the science of facial symmetry analysis with the art of hairstyling and personal color choice to bring harmony and balance to the face and to enhance its symmetrical, and therefore attractive, appearance.

### SUMMARY OF THE INVENTION

The present invention relates to a method of analyzing a person's facial features to assist in facial image makeover and hair styling comprising:
(a) uploading a working image of the person onto a computer;
(b) determining horizontal balance data;
(c) determining spatial balance data;
(d) determining feature balance data;
(e) determining natural hair growth pattern data;
(f) determining color balance data; and
(g) providing beauty advice to enhance the appearance of a more symmetrical face.

These and other features, aspects, and advantages of the present invention will become evident to those skilled in the art from a reading of the present disclosure.

### BRIEF DESCRIPTION OF THE DRAWINGS

FIG. 1 is a representation of a vertical line bisecting the working image at the center of the face.

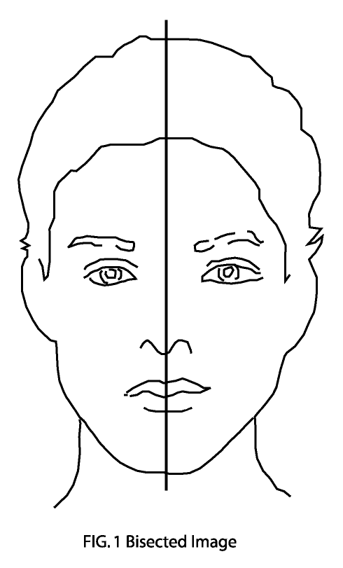

FIG. 2 is a representation of three horizontal lines positioned over the working image to determine horizontal balance data.

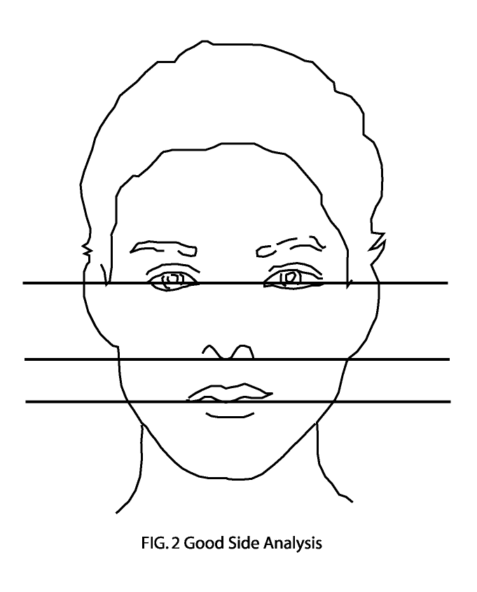

FIG. 3 is a representation of four horizontal lines positioned over the working image to determine spatial balance data.

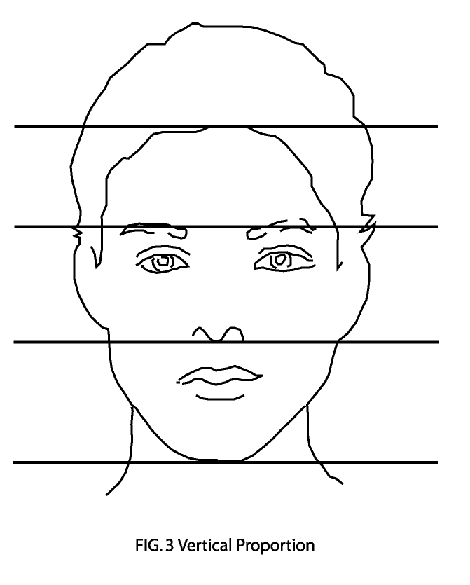

FIG. 4 is a representation of positioning an oval representation over the working image to determine spatial balance data.

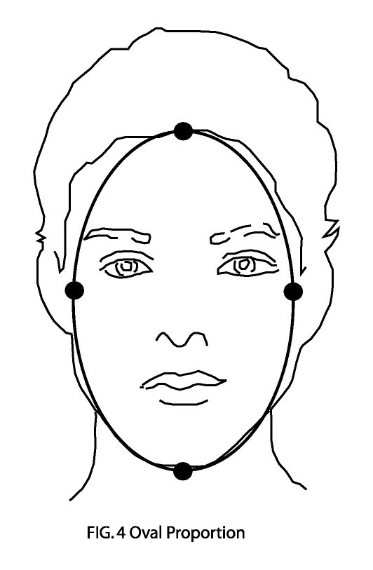

FIG. 5 is a representation of four vertical lines over the working image to determine feature balance data.

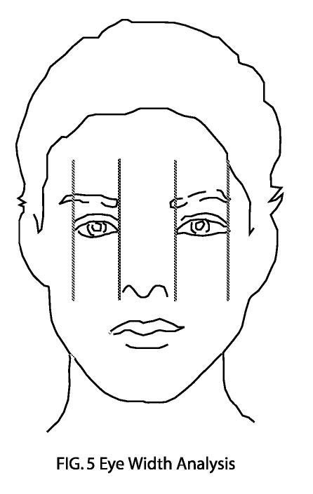

FIG. 6 is a representation of four rays positioned over the working image from an anchor point at the edge of each nostril and passing through reference points located at the outer corners of the eyes to determine feature balance data.

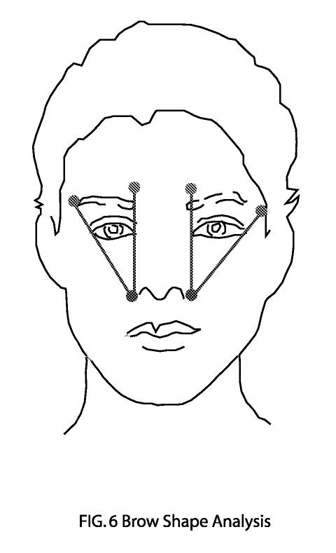

FIG. 7 is a representation of a horizontal line positioned over the working image at the level of the lower-sitting ear lobe to determine feature balance data.

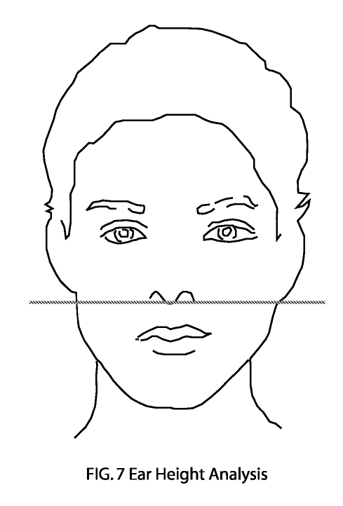

FIG. 8 is a representation of determining natural hair growth data.

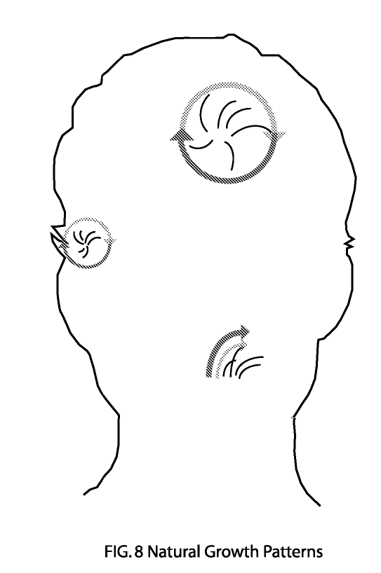

FIG. 9 is a representation of determining the color balance data.

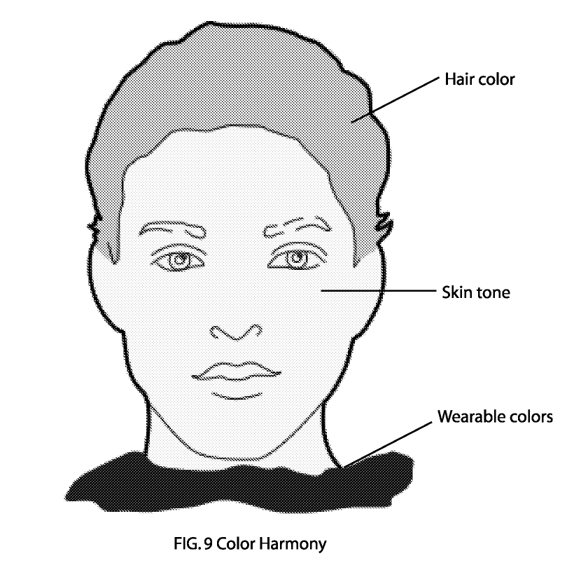

FIG. 10 is a representation of selecting eyewear to complement the symmetry of the face.

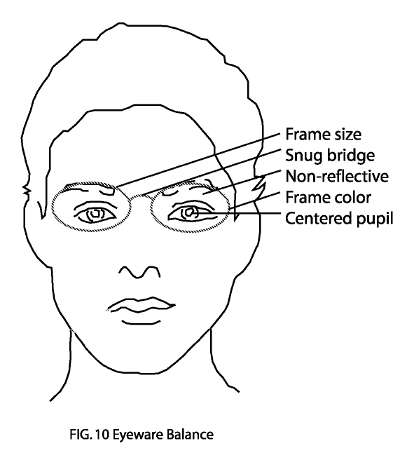

FIG. 11 is a representation of an embodiment of the present invention.

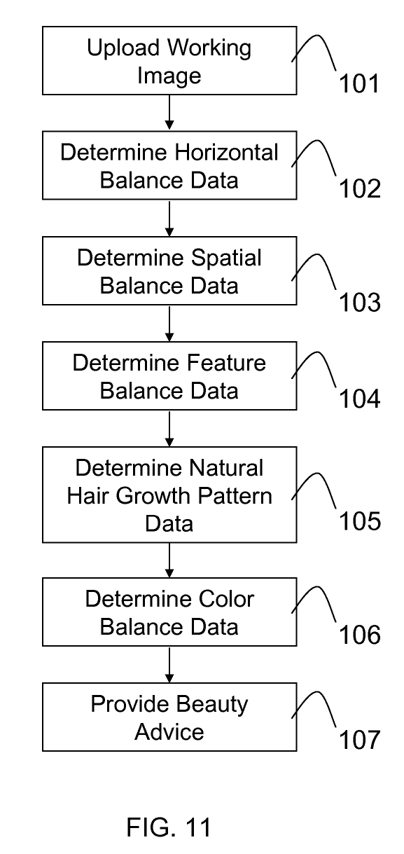

FIG. 12 is a representation of an embodiment of the present invention.

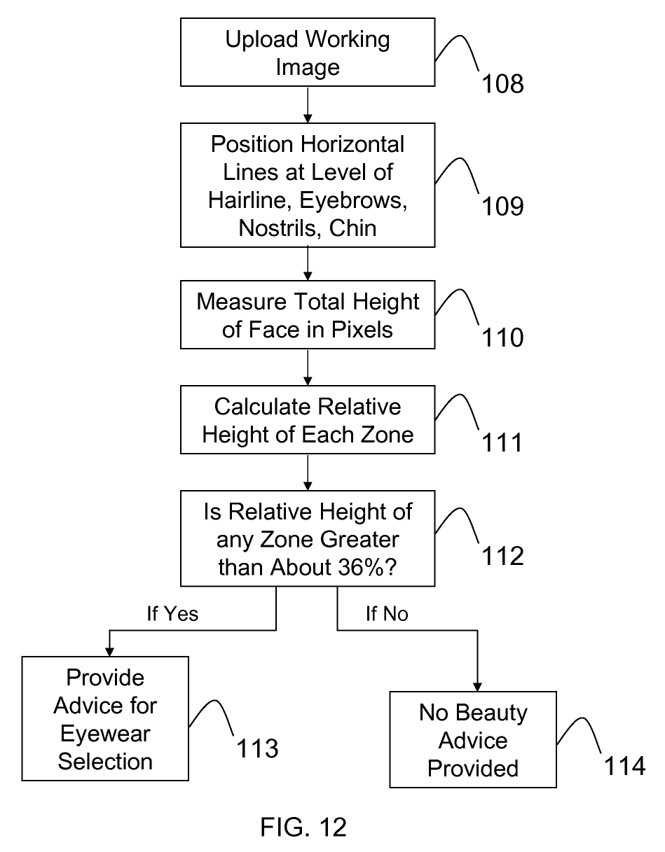

FIG. 13 is a representation of an embodiment of the present invention.

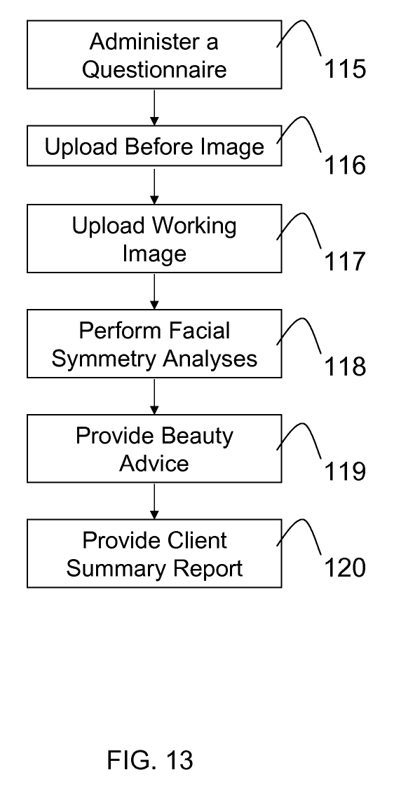

### DETAILED DESCRIPTION OF THE INVENTION

While the specification concludes with claims that particularly point out and distinctly claim the invention, it is believed that the present invention will be better understood from the following description.

The term “working image,” as used herein, means a photograph of a person taken such that the person's head is vertically erect, the person's face encompasses the entire frame, the person is unsmiling with mouth closed, the person's excessive makeup is removed, and the person's hair is pulled back so that the natural hairline and all facial features are readily visible. The working image of the present invention may be generated using digital or film photographic technology. If generated digitally, the working image is uploaded onto a computer for use in the present invention. If generated using film photography, the working image is scanned into the computer for use in the present invention using conventional scanning equipment.

The term “before image,” as used herein, means a head and shoulders, relaxed and smiling photograph of a person with the person's hair and makeup worn in the usual manner.

The term “after image,” as used herein, means a relaxed and smiling photograph of a person with the person's hair and makeup worn in accordance with the beauty advice of the present invention. If the person selected a new haircut and style based on the beauty advice, then the after image is taken after receiving the new haircut and style. If the person did not opt for a new haircut, then the person's hair is styled in conformity with the beauty advice received.

The term “horizontal balance data,” as used herein, comprises two sets of measurements, the first being the placement of a set of three horizontal lines at designated points of the face comprising the level of the higher-sitting outside corner of the eyes, the level of the higher-sitting outside corner of the lips, and the level of the higher sitting edge of the nostrils; and the second being the creation of two symmetrical composite images of the face, the result being a determination of which side of the face comprises a majority of higher-sitting key features.

The term “analyst,” as used herein, means a person trained to use the present invention. The analyst may be selected from the group consisting of hair stylists, cosmetologists, beauty salon personnel, personal beauty consultants, and other individuals skilled in the use of the present invention.

The terms “higher-sitting” and “higher-set,” as used herein, mean a facial feature located at a greater vertical distance above a referential horizontal line than the counterpart of that facial feature on the opposite side of the face.

The terms “lower-sitting” and “lower-set,” as used herein, mean a facial feature located at a greater vertical distance below a referential horizontal line than the counterpart of that facial feature on the opposite side of the face.

The term “bisect the working image down the center of the face,” as used herein, means to position a vertical line over the working image such that the vertical line intersects the Cupid's bow, or center of the double curve of the upper lip.

The term “symmetrical composite image,” as used herein, means an image obtained by bisecting the working image down the center of the face and creating an image comprising a contiguous view of one side of the face and the mirror image of that side of the face. A symmetrical composite image of the present invention may comprise the left side of the face and the mirror image of the left side of the face or may comprise the right side of the face and a mirror image of the right side of the face.

The term “positive-appearing facial expression,” as used herein, means having fuller, higher-sitting eyes, higher-sitting nostrils, and higher-sitting or upturned mouth corners. The term “good side,” as used herein, means the side of the face having a more positive-appearing facial expression.

The term “spatial balance data,” as used herein, comprises two sets of measurements, the first being an analysis of a person's face with regard to an oval representation superimposed on the working image, and the second being the relative vertical height of the top, middle, and bottom zones of the face. The term “top zone,” as used herein, means the zone of the face defined by the vertical distance in pixels from the level of the hairline above the forehead to the mid-level of the eyebrows. The term “mid-level of the eyebrows,” as used herein, means a point halfway between the highest point of the higher-sitting eyebrow and the lowest point of the lower-sitting eyebrow. The term “middle zone,” as used herein, means the zone of the face defined by the vertical distance in pixels from the mid-level of the eyebrows to the bottom edge of the nostrils. The term “bottom zone,” as used herein, means the zone of the face defined by the vertical distance in pixels from the bottom edge of the nostrils to the bottom edge of the chin.

The term “feature balance data,” as used herein, comprises three sets of measurements, the first comprising analyzing the placement of the inner and outer eye corners to determine the average eye width in pixels, the horizontal distance between the eyes in pixels, and the ratio of the average eye width and the horizontal distance between the eyes; the second comprising the placement of the eyebrow ends relative to imaginary rays running from the nostril edges and extending up through each corner of each eye; and the third being the location on the head of the lowest point of the lower ear lobe relative to the vertical placement of the opposite ear.

The present invention refers to the spatial arrangement of the person's eyes relative to other features on the face. The term “balanced eyes,” as used herein, means the average of the widths of the left and right eyes and the width of the space between the eyes are within about 4%. The term “close set eyes,” as used herein, means the average of the widths of the left and right eyes is more than about 4% greater than the width of the space between the eyes. The term “wide set eyes,” as used herein, means the average of the widths of the left and right eyes is more than about 4% less than the width of the space between the eyes.

The term “natural hair growth pattern data,” as used herein, means identifying the location of any whorls and cowlicks on the head of a person and inputting on a computer the location and direction of growth of any whorls and cowlicks on a generic illustration of a human scalp or hairline.

The term “whorl,” as used herein, means a formation of hair on the head that grows in a coil or spiral pattern.

The term “cowlick,” as used herein, means a projecting tuft of hair on the head that grows in a different direction from the rest of the hair and will not lie flat against the head.

The term “razor cut,” as used herein, means to shave, cut, or remove hair with a razor.

The term “color balance data,” as used herein, comprises both a skin tone analysis and a hair color analysis. The term “skin tone analysis,” as used herein, means sequentially presenting a set of seven pairs of colors, each pair having a cool hue and a warm hue, and determining a person's preference for warm or cool hues. The term “hair color analysis,” as used herein, means presenting a plurality of images of hair color swatches selected from the group consisting of level one, level two, level three, level four, level five, level six, level seven, level eight, level nine, and level ten in order to determine the natural hair color of the person.

The term “dark shades of eye makeup,” as used herein, means shades of eye makeup that reflect little light. Examples of dark shades of eye makeup include, for example, shades selected from the group consisting of navy blue, black, charcoal, pewter, brown, grey, hunter green, and deep purple. The skilled artisan will understand which shades of eye makeup are considered dark shades for the purposes of the present invention.

The term “light shades of eye makeup,” as used herein, means shades of eye makeup that reflect more light. Examples of light shades of eye makeup include, for example, shades selected from the group consisting of white, silver, tan, peach, pink, ice blue, gold, and lilac. The skilled artisan will understand which shades of eye makeup are considered light shades for the purposes of the present invention.

The term “inner one-third of the eyelid,” as used herein, means the area of the eyelid from the eyelash to the eyebrow, extending from the inner corner of the eye outward one-third the horizontal distance to the outer eye corner.

The term “outer one-third of the eyelid,” as used herein, means the area of the eyelid from the eyelash to the eyebrow, extending from the outer corner of the eye inward one-third the horizontal distance to the inner eye corner.

The term “hue,” as used herein, means the gradation of a skin color. The term “warm hue,” as used herein, means a gradation of skin color having a majority presence of yellow (carotene) undertones. Warm hues include gradations of colors having a golden tint. The term “cool hue,” as used herein, means a gradation of skin color having a majority presence of red (hemoglobin) undertones. Cool hues include gradations of colors having a pinky-blue tint.

The term “blue-based colors, as used herein, means any of a group of colors that may vary in lightness and saturation, whose underlying hue resembles that of a clear daytime sky.

The term “yellow-based colors,” as used herein, means any of a group of colors that may vary in lightness and saturation, whose underlying hue resembles that of ripe lemons.

The term “tone,” as used herein, means the shade or tint of a color.

The term “hair color levels,” as used herein, mean the degree of lightness or darkness of a hair color that is reflected or seen by the eye. One skilled in the hairstyling art will understand that hair color may be assigned a level value from one to ten, level one being black, which reflects very little light, and level ten being lightest blonde, which reflects the greatest amount of light. This system of hair color levels is well-known in the art, and may be applied to all hair colors. See, e.g., Roxy Warren, Haircoloring in Plain English: A Practical Guide for Professionals (1998); Deborah Rangle, Milady's Standard Hair Coloring Manual and Activities Book: A Level System Approach (1997).

In one embodiment of the present invention, a method of analyzing a person's facial features to assist in facial image makeover and hair styling is provided, comprising uploading a working image 101 of the person onto a computer, determining horizontal balance data 102, determining spatial balance data 103, determining feature balance data 104, determining natural hair growth pattern data 105, determining color balance data 106, and providing beauty advice 107 to enhance the appearance of a more symmetrical face.

In one embodiment of the invention, the working image may be obtained using digital photography methods. In another embodiment of the invention, the working image may be obtained using film photography methods. If the working image is a digital image, the image may be uploaded onto a computer of the present invention. If the working image is a film image, the image may be scanned into a computer of the present invention using conventional scanning equipment known in the art.

Determining Horizontal Balance Data

In one embodiment of the present invention, a series of three horizontal lines are positioned over the working image at the level of indicated facial features. A first horizontal line of the horizontal balance data is positioned over the working image at the level of the higher-sitting outside corner of the eyes. A second horizontal line of the horizontal balance data is positioned over the working image at the level of the higher-sitting corner of the lips. A third horizontal line of the horizontal balance data is positioned over the working image at the level of the higher-sitting outside edge of the nostrils. The analyst may then note on the computer each feature that sits higher on the working image of the client's face. Features sitting at the same height are noted to be balanced. The analyst then determines which side of the face comprises a majority of higher-sitting features. For example, if the left outside corner of the eye and left corner of the lips are higher-sitting but the nostrils are balanced, the analyst will determine that the left side of the face has a majority of higher-sitting features.

In another embodiment of the present invention, a vertical line is positioned over the working image in order to bisect the working image down the center of the face. The computer program of the present invention then creates two symmetrical composite images, the first symmetrical composite image comprising the left side of the face and the mirror image of the left side of the face, and the second symmetrical composite image comprising the right side of the face and the mirror image of the right side of the face. The analyst determines whether the first symmetrical composite image or the second symmetrical composite image provides a more positive-appearing facial expression and notes the selection on the computer. The program of the present invention may then provide the person with advice to direct hair away from the side of the face that provides a more positive-appearing facial expression.

Determining Spatial Balance Data

In yet another embodiment of the present invention, two sets of measurements are taken, the first being an analysis of a person's face with regard to an oval representation superimposed on the working image, and the second being the relative vertical height of the top, middle, and bottom zones of the face.

In one embodiment of the invention, an oval representation is positioned over the working image along the contour of the person's face. The analyst may then identify the presence of hair showing inside the oval representation along the hairline. If such is indicated, the analyst may advise person to direct hair away from the location where hair is showing inside the oval representation along the hairline. In another embodiment of the invention, the analyst may identify the presence of bare skin showing outside the oval representation along the hairline. If such is indicated, the analyst may advise the person to direct hair toward the location where bare skin is showing outside the oval representation along the hairline. In yet another embodiment of the invention, the analyst may identify the absence of bare skin showing inside the oval representation along the jaw line. If such is indicated, the analyst may advise the person to direct hair away from the location where the absence of bare skin is observed inside the oval representation along the jaw line. In still another embodiment of the present invention, the analyst may identify the presence of bare skin showing outside the oval representation along the jaw line. If such is indicated, the analyst may advise the person to direct hair toward the location where the presence of bare skin is observed outside the oval representation along the jaw line.

In another embodiment of the present invention, the relative vertical height of the top, middle, and bottom zones of the face is determined. The analyst positions a first horizontal line of the spatial balance data over the working image at the level of the hairline above the forehead; a second horizontal line of the spatial balance data over the working image at the mid-level of the eyebrows; a third horizontal line of the spatial balance data over the working image at the level of the bottom edge of the nostrils; and a fourth horizontal line of the spatial balance data over the working image at the level of the bottom edge of the chin. The program of the present invention measures in pixels the total height of the face between the first horizontal line and the fourth horizontal line of the spatial balance data. The program of the present invention further measures the relative height of the top zone between the first horizontal line of the spatial balance data and the second horizontal line of the spatial balance data as compared with the total height of the face. The program of the present invention measures the relative height of the middle zone between the second horizontal line of the spatial balance data and the third horizontal line of the spatial balance data as compared with the total height of the face. The program of the present invention measures the relative height of the bottom zone between the third horizontal line of the spatial balance data and the fourth horizontal line of the spatial balance data as compared with the total height of the face. The person may be advised to direct hair away from a zone if the relative height of the zone is less than about 30%. The person may further be advised to direct hair toward a zone if the relative height of the zone is greater than about 36%.

Determining Feature Balance Data

In another embodiment of the present invention, three sets of measurements are determined, the first comprising analyzing the placement of the inner and outer eye corners to determine the average eye width in pixels, the horizontal distance between the eyes in pixels, and the ratio of the average eye width and the horizontal distance between the eyes; the second comprising the placement of the eyebrow ends relative to imaginary rays running from the nostril edges and extending up through a reference point located at each corner of each eye; and the third comprising the location on the head of the lowest point of the lower ear lobe relative to the vertical placement of the opposite ear.

In one embodiment of the present invention, a first vertical line of the feature balance data is positioned over the working image at the location of the outer corner of the left eye; a second vertical line of the feature balance data is positioned over the working image at the location of the inner corner of the left eye; a third vertical line of the feature balance data is positioned over the working image at the location of the inner corner of the right eye; and a fourth vertical line of the feature balance data is positioned over the working image at the location of the outer corner of the right eye. The program of the present invention then measures in pixels the width of the left eye between the first and second vertical lines of the feature balance data. The program of the present invention then measures in pixels the width of the right eye between the third and fourth vertical lines of the feature balance data. The program of the present invention then determines the average of the widths of the left and right eyes and the width of the space between the eyes between the second and third vertical lines of the feature balance data. The average of the widths of the left and right eyes with the width of the space between the eyes are then compared, and the eyes are determined to either be balanced, close-set, or wide-set. By the method of the present invention, the eyes are considered balanced if the average of the widths of the left and right eyes and the width of the space between the eyes are within about 4%. The eyes are considered to be close-set if the average of the widths of the left and right eyes is more than about 4% greater than the width of the space between the eyes. The eyes are considered to be wide-set if the average of the widths of the left and right eyes is more than about 4% less than the width of the space between the eyes. If the eyes are determined to be close-set, the person is advised to direct hair away from the eyes and to apply light shades of eye makeup to the outer one-third of the eyelid. If the eyes are determined to be wide-set, the person is advised to direct hair toward the eyes and to apply dark shades of eye makeup to the outer one-third of the eyelid.

In yet another embodiment of the present invention, the placement of the eyebrow ends relative to two sets of imaginary rays running from the nostril edges and extending upward through each corner of each eye are examined. A first ray is positioned over the working image from a first anchor point located at the outside left nostril and through a first reference point located at the inside corner of the left eye; a second ray is positioned over the working image from the first anchor point located at the outside left nostril and through a second reference point located at the outside corner of the left eye; a third ray is positioned over the working image from a second anchor point located at the outside right nostril and through a third reference point located at the inside corner of the right eye; a fourth ray is positioned over the working image from the second anchor point located at the outside right nostril and through a fourth reference point located at the outside corner of the right eye. The analyst then advises the person to adjust the length of the eyebrows, following their natural curvature, such that the brows meet but do not extend past the set of imaginary rays corresponding to the appropriate side of the face. The person is advised to adjust left eyebrow length to match the space defined between the first and second rays, and to adjust right eyebrow length to match the space defined between the third and fourth rays. Eyebrow length may be shortened by tweezing or waxing; eyebrow length may be extended with the aid of makeup application.

In another embodiment of the present invention, the location on the head of the lowest point of the lower ear lobe relative to the vertical placement of the opposite ear is determined. A horizontal line is positioned over the working image at the level of the bottom edge of the lower-sitting ear lobe. The analyst notes which ear lobe, if any, is lower-sitting. The person is then advised that hair growth is usually thicker on the side of the head with the lower-sitting ear. The person may be further advised to cut hair evenly about the face, rather than to ear-level, in order to avoid an uneven hairstyle.

Determining Natural Hair Growth Pattern Data

In an embodiment of the invention, the natural hair growth pattern of a person's head is determined by recording the location and direction of the person's whorls and cowlicks on a generic illustration of the human scalp. The analyst locates the person's main whorl, which is defined as the primary growth pattern of hair on or near the head's crown. The analyst moves an icon representing either a clockwise or counter-clockwise direction of the main whorl to an illustrated drawing of the back of a human head to a point approximating its location on the person's head. If a secondary whorl is observed, the analyst moves an icon representing either a clockwise or counter-clockwise direction of a secondary whorl to the same illustrated drawing of the back of a human head to a point approximating its location on the person's head. If any cowlicks are observed, the analyst moves an icon representing the cowlicks and their directions of growth to the same illustrated drawing of the back of a human head or to an illustrated drawing of the front of a human head. The icons are placed at points approximating their location on the client's frontal hairline or rear neckline. The person may then be advised comb hair in the same direction as a whorl to achieve a smooth hair appearance or to comb hair in the opposite direction as a whorl to achieve a voluminous hair appearance. The person may be further advised to razor cut hair from a cowlick to minimize its effect or to lift hair at the location of a cowlick to maximize its effect.

Determining Color Balance Data

In still another embodiment of the present invention, the color balance data is determined. The color balance data may further comprise a skin tone analysis and a hair color analysis.

In an embodiment of the invention, skin tone analysis is performed by presenting sequentially seven pairs of color swatch images, each pair comprising a warm hue image and a cool hue image. The analyst may instruct the person to select the preferred color swatch image from each sequentially presented pair. The computer program of the present invention calculates the number of cool or warm color selections and returns a result of cool or warm skin tone based on a majority of at least four colors being cool or warm. The person may then be advised that blue-based colors complement a cool skin tone, while yellow-based colors complement a warm skin tone.

In another embodiment of the invention, hair color analysis is performed by presenting a plurality of images of hair color swatches selected from the group consisting of level one, level two, level three, level four, level five, level six, level seven, level eight, level nine, and level ten on the system of hair color gradation known in the art as the level system. See, e.g., Roxy Warren, Haircoloring in Plain English: A Practical Guide for Professionals (1998); Deborah Rangle, Milady's Standard Hair Coloring Manual and Activities Book: A Level System Approach (1997). The analyst selects the image of the hair color swatch that best matches the person's natural hair color, as noted at the roots of the hairline. The analyst further enters the hue, either warm or cool, of the person's skin tone. The person may then be advised to use a hair color within two levels of the person's natural hair color to complement skin tone. For example, if a person's natural hair color is level four, the person may be advised to use a hair color matching any of the levels two through six in order to complement skin tone.

Determining Recommended Eyewear

In a further embodiment of the present invention, a method of analyzing a person's facial features to assist in selecting eyewear to complement the symmetry of the face is provided. First, a working image of the person is uploaded or scanned into a computer 108. The analyst positions a first horizontal line over the working image at the level of the hairline above the forehead; a second horizontal line over the working image at the mid-level of the eyebrows; a third horizontal line over the working image at the level of the bottom edge of the nostrils; and a fourth horizontal line over the working image at the level of the bottom edge of the chin 109. The program of the present invention measures in pixels the total height of the face between the first horizontal line and the fourth horizontal line of the spatial balance data 110. The program of the present invention further measures the relative height of the top zone between the first horizontal line of the spatial balance data and the second horizontal line of the spatial balance data as compared with the total height of the face 111. The program of the present invention measures the relative height of the middle zone between the second horizontal line of the spatial balance data and the third horizontal line of the spatial balance data as compared with the total height of the face 111. The program of the present invention measures the relative height of the bottom zone between the third horizontal line of the spatial balance data and the fourth horizontal line of the spatial balance data as compared with the total height of the face 111.

The person may then be provided advice 112 regarding eyewear selection if the relative height of the top zone, middle zone, or bottom zone is greater than about 36% 113. If the relative height of any of the top zone, middle zone, or bottom zone is less than about 36%, then no advice is provided 114. For example, a person having a large top zone may be advised to select very thin or rimless frames with a light nose bridge that does not sit too high on the face. The person may be further advised to select frames that are wider at the bottom edge of the lens than the top edge of the lens, in a color that matches eye color or complements skin tone. A person having a large middle zone may be advised to select frames with a larger bridge and wider temple sidebars, in order to draw attention upwards. The person may be further advised to select frames in dark colors that complement skin tone. A person having a large bottom zone may be advised to select frames that draw attention upwards, having bold colors that complement skin tone.

### Further Embodiments

In still another embodiment of the present invention, a method of using a computer to analyze a person's facial features to assist in facial image makeover and hair styling is provided, comprising administering a questionnaire 115, uploading a before image of the person onto a computer 116, uploading a working image of the person onto the computer 117, performing facial symmetry analyses 118, providing beauty advice 119 to enhance the symmetrical appearance of a face, and providing a report 120 comprising said beauty advice to the person. In one embodiment of the invention, performing facial symmetry analyses may comprise determining horizontal balance data, determining spatial balance data, determining feature balance data, determining natural hair growth pattern data, determining color balance data, and determining recommended eyewear.

In yet another embodiment, the invention may further comprise styling the person's hair in accordance with said beauty advice, applying makeup to the person in accordance with said beauty advice, applying hair coloring to the person in accordance with said beauty advice, obtaining an after image of the person, uploading the after image of the person into the computer, and recommending beauty products to the person in accordance with said beauty advice.

In still another embodiment of the invention, a computer-readable medium containing instructions to configure the central processor of a computer to perform the methods of the present invention is provided. The computer-readable medium may further comprise computer software.

All documents cited are, in relevant part, incorporated herein by reference; the citation of any document is not to be construed as an admission that it is prior art with respect to the present invention.

The method of the present invention can comprise, consist of, or consist essentially of the essential elements and limitations of the invention described herein, as well as any of the additional or optional ingredients, components, or limitations described herein.

### EXAMPLES

### Example 1

Pre-Analysis Data

A 37 year-old Caucasian woman arrives at the salon for analysis by the method of the present invention. She completes a multiple choice computer hair care and lifestyle questionnaire about grooming habits, product usage, personal image perception, and color preference. The before image of the woman is generated, which comprises taking a head and shoulders, relaxed and smiling digital photograph of the woman with her hair worn in the usual manner. The working image of the woman is generated, which comprises taking a head only, non-smiling, closed mouth, straight face digital photograph with her hair pulled back to reveal the natural hairline. Both photographs are uploaded into the computer. The before photo is adjusted for color balance. The working image is adjusted for color balance and rotated so that the woman's face is vertically aligned. The analyst advises the person that images on the computer screen display as a mirror image, meaning that the person's left side will appear on the right as if looking in a mirror. The analyst reviews a summary of the upcoming five analysis steps: horizontal balance, spatial balance, feature balance, natural hair growth patterns, and color balance.

Each analysis step comprises an Introduction page including text and animated illustrations explaining the section concept; one or more Analysis pages comprising moveable measuring and analysis tools applicable to the section and a data recording area; a Takeaway page comprising a review of the concept, summary of the recorded data, and a Summary comprising guidelines for hair styling, make-up application, coloring services, and color selection.

Horizontal Balance Data

The analyst begins by collecting the horizontal balance data to determine the side of the face with a more positive-appearing expression. First, the analyst demonstrates the upcoming step using both textual content and animated illustrations. Preexisting horizontal color coded lines are positioned on the working image. A first line is adjusted to intersect the lower-sitting eye corner. A second line is adjusted to intersect the bottom of the lower-sitting nostril. A third line is adjusted to intersect the lower-sitting lip corner. The analyst notes on the computer each higher-sitting feature on the working image of the client's face. Features sitting at the same height are noted to be balanced. The analyst notes that the woman's right eye and right nostril area higher-sitting, and her lip corners are balanced. On the next screen, the analyst positions a vertical line to the center of the face, as determined by the midpoint of the upper lip. Photographic composites of mirror images comprised of two left sides of the face and two right sides of the face are compared. The photographic composite rendering a more positive expression is selected. A positive expression is indicated by fuller, higher-sitting eyes, higher-sitting nostrils and higher-sitting or upturned mouth corners. The analyst notes the photo having a more positive expression on the computer by choosing the right/right composite photo. The analyst advances to a summary screen to review the horizontal balance concept, the client's personalized data, and styling guidelines that can be used by a hairdresser to direct hair away from the right side of the face, with the effect being a brighter, more positive facial appearance.

Spatial Balance Data

The analyst collects spatial balance data to determine the relative balance of facial zones ranging from top to bottom and calculates which facial zone, if any, is out of balance with the other zones. Zones equaling about 30 to about 36 percent of total face height are considered balanced. First, the analyst demonstrates the upcoming step using both textual content and animated illustrations. Preexisting horizontal color-coded lines are positioned over the working image. A first line is positioned at the hairline. A second line is positioned at the middle of the brow line. A third line is positioned at the bottom edge of the lower nostril. A fourth line is positioned at the bottom edge of the chin. The relative height of each zone is calculated. The analyst notes that the woman's top zone has a relative height of 29%, her middle zone has a relative height of 33%, and her bottom zone has a relative height of 38%. The analyst advises the woman to direct hair away from the top zone, and to direct hair toward the bottom zone to give the appearance of a more balanced and visually attractive face.

On the next screen, the analyst positions an oval representation over the working image to compare the amount of visible skin or hair appearing outside or inside an ideal oval shape. The analyst drags color coded circles positioned at the top, bottom and both sides of the oval. The top circle is dragged to the centermost point of the hairline, the bottom circle is dragged to the lowermost center point of the chin, and each side circle is dragged to an area on the temporal hairline and adjusted until the oval appears symmetrical. The analyst notes the presence of bare skin showing outside the oval on the forehead and an absence of bare skin showing inside the oval representation along the jaw line. The analyst advances to a summary screen to review the spatial balance concept, the client's personalized data, and styling guidelines. The woman is advised to direct hair away from the jaw line to give the appearance of a more balanced and visually attractive face, and further advised to direct hair toward the forehead.

Feature Balance Data

The analyst collects feature balance data to determine the relative position of the woman's eyes, eyebrows, and ears. First, the analyst demonstrates the upcoming step using both textual content and animated illustrations. Preexisting vertical color-coded lines are positioned over the working image. The outside left line is positioned at the right outer eye corner. The inside left line is positioned at the right inner eye corner. The inside right line is positioned at the left inner eye corner. The outside right line is positioned at the left outer eye corner. The computer calculates the width between the eyes relative to the average width of both eyes to determine whether eyes are wide-set, close-set, or balanced. The woman's eyes are determined to be close-set since the average of the widths of the eyes is 6% greater than the width of the space between the eyes. The woman is advised to direct hair away from close-set eyes and apply light shades of eye makeup to the outer one-third of the eyelid to give the appearance of a more balanced and visually attractive face.

On the next screen, the analyst positions a first ray over the working image from an anchor point located at the outside left nostril and through a reference point located at the inside corner of the left eye. She positions a second ray over the working image from an anchor point located at the outside left nostril and through a reference point located at the outside corner of the left eye, the result being two rays intersecting at the nostril and extending upward to frame the eyebrow. A third ray is positioned over the working image from an anchor point located at the outside right nostril and through a reference point located at the inside corner of the right eye. A fourth ray is positioned over the working image from an anchor point located at the outside right nostril and through a reference point located at the outside corner of the right eye, the result being two rays intersecting at the nostril and extending upward to frame the eyebrow. The ideal eyebrow will extend to meet, but not intersect or extend past these rays. The analyst notes the woman's eyebrows are too long at the outside of her eyes. The woman is advised to tweeze or wax to shorten the brows.

On the next screen, a horizontal line is positioned over the working image at the level of the lower-set ear. The analyst notes that the woman's right ear is higher-sitting. The client is advised that there is usually less hair growth over the higher ear. The analyst advises the client to cut short or bobbed hair evenly about the face rather than to ear level.

The analyst then advances to a summary screen to review the feature balance concepts, the client's personalized data, and styling, makeup or hair care products that can be used by a hairdresser or by the client at home.

Natural Growth Pattern Data

The analyst advances to the next screen and collects data on the natural growth pattern of the hair. First, the analyst demonstrates the upcoming step using both textual content and animated illustrations. The analyst locates the woman's main whorl, defined as the primary growth pattern of hair on or near the head's crown and determines the rotational direction of growth. The analyst moves an icon representing the main whorl and its counterclockwise direction of growth to an illustrated drawing of the back of a human head to a point approximating its location on the client's head. The analyst locates the woman's cowlick and moves an icon representing the cowlick and its clockwise direction of growth to the same illustrated drawing of the back of a human head. The client is advised to comb hair in the same direction as a whorl to achieve a smooth appearance, and in the opposition direction of the whorl to achieve a voluminous appearance. The client is advised to razor cut hair from the cowlick to minimize its effect and to lift hair at the location of the cowlick to maximize its effect. The analyst advances to a summary screen to review the natural growth pattern concepts, the client's personalized data for whorls and cowlicks, and grooming guidelines for managing whorls and cowlicks.

Color Balance Data

The analyst advances to the next screen and demonstrates the upcoming step using both textual content and animated illustrations. The analyst asks the woman to choose from a set of seven pairs of color swatches, of which one is a cool color with blue undertones and the other is a warm color with yellow undertones. The woman is asked to choose the color that she believes looks better on her. The woman is directed to choose one color from each pair; a number bar is provided to go “back” to review the colors choices if necessary. The computer calculates the woman's skin tone is cool since the woman selected the cool hue at least four out of seven times, in six of the seven pairs. The analyst advises the woman that for radiant, brighter-looking skin tone she should use hair coloring close to her natural hair color and a cool shade matching her skin tone. She is further advised that the natural process of hair lightening produces warm tones. The analyst records the woman's natural hair color level by selecting a level and tone (either cool or warm) from an illustrated chart on the computer screen. The analyst selects level five and cool tone to match the woman's hair color. The analyst advances to a summary screen to review the color balance concepts, the woman's personalized data for skin tone and natural hair color levels, and recommendations. Recommendations for wearable colors are viewed as small color swatches for basic wardrobe colors (blue, green violet for cool skin tone; red, yellow, orange for warm skin tone), other wardrobe colors (blue undertone colors for cool skin tone), and accessories (silver, blue-gray, cool-beige for cool skin tone). Recommendations for hair coloring are viewed as small swatches illustrating the 10 Levels of natural hair color with an indicator pointing to the woman's acceptable range of levels, within two levels of her natural hair color, level five. The woman's hair coloring shade is stated as cool.

Post-Analysis Data

Recommendations for horizontal balance, spatial balance, feature balance, natural hair growth pattern, and color balance are reviewed. The woman and analyst review the answers to the woman's pre-analysis hair care and lifestyle questionnaire and together with the analysis recommendations plan salon services. The woman opts for a new cut, style, coloring and makeup session. After salon services are performed, the client poses for a relaxed, smiling after image. The after image is uploaded onto the computer. The analyst completes a multiple choice hair care data form that is recorded as stylist's recommendations for shampoo, conditioner, styling aids, brush type and styling tools.

Client Profile Data

Recorded data from the entire analysis is compiled and printed onto a full-color, 6-page 8½11″ Client Profile. The cover page includes the inventor's logo, name and address and custom logo of the salon, name of the client, name of the analyst, and date of the service. Inside pages include all personalized data recorded during the analysis and presented on each summary page, including color swatches and photographic images of the client's face with the analysis tools in place.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of analyzing a person's facial features to assist in facial image makeover and hair styling comprising:
(a) uploading a working image of the person onto a computer;
(b) determining horizontal balance data;
(c) determining spatial balance data;
(d) determining feature balance data;
(e) determining natural hair growth pattern data;
(f) determining color balance data; and
(g) providing beauty advice to enhance the appearance of a more symmetrical face.

2. The method of claim 1 wherein determining the horizontal balance data comprises:
(a) positioning a first horizontal line of the horizontal balance data over the working image at the level of the higher-sitting outside corner of the eyes;
(b) positioning a second horizontal line of the horizontal balance data over the working image at the level of the higher-sitting corner of the lips;
(c) positioning a third horizontal line of the horizontal balance data over the working image at the level of the higher-sitting outside edge of the nostrils; and
(d) determining which side of the face comprises a majority of higher-sitting features.

3. The method of claim 2 wherein determining the horizontal balance data comprises:
(a) positioning a vertical line over the working image in order to bisect the working image down the center of the face;
(b) creating a first symmetrical composite image comprising the left side of the face and the mirror image of the left side of the face;
(c) creating a second symmetrical composite image comprising the right side of the face and the mirror image of the right side of the face;
(d) determining whether the first symmetrical composite image or the second symmetrical composite image provides a more positive-appearing facial expression;
(e) selecting the side of the face that provides a more positive-appearing facial expression; and
(f) advising the person to direct hair away from the side of the face that provides a more positive-appearing facial expression.

4. The method of claim 1 wherein determining the spatial balance data comprises:
(a) positioning an oval representation over the working image along the contour of the person's face;
(b) identifying the presence of hair showing inside the oval representation along the hairline; and
(c) advising the person to direct hair away from the location where hair is showing inside the oval representation along the hairline.

5. The method of claim 1 wherein determining the spatial balance data comprises:
(a) positioning an oval representation over the working image along the contour of the person's face;
(b) identifying the presence of bare skin showing outside the oval representation along the hairline; and
(c) advising the person to direct hair toward the location where bare skin is showing outside the oval representation along the hairline.

6. The method of claim 1 wherein determining the spatial balance data comprises:
(a) positioning an oval representation over the working image along the contour of the person's face;
(b) identifying the absence of bare skin showing inside the oval representation along the jaw line; and
(c) advising the person to direct hair away from the location where the absence of bare skin is observed inside the oval representation along the jaw line.

7. The method of claim 1 wherein determining the spatial balance data comprises:
(a) positioning an oval representation over the working image along the contour of the person's face;
(b) identifying the presence of bare skin showing outside the oval representation along the jaw line; and
(c) advising the person to direct hair toward the location where the presence of bare skin is observed outside the oval representation along the jaw line.

8. The method of claim 1 wherein determining the spatial balance data comprises:
(a) positioning a first horizontal line of the spatial balance data over the working image at the level of the hairline above the forehead;
(b) positioning a second horizontal line of the spatial balance data over the working image at the mid-level of the eyebrows;
(c) positioning a third horizontal line of the spatial balance data over the working image at the level of the bottom edge of the nostrils;
(d) positioning a fourth horizontal line of the spatial balance data over the working image at the level of the bottom edge of the chin.
(e) measuring the total height of the face between the first horizontal line and the fourth horizontal line of the spatial balance data;
(f) determining the relative height of the top zone between the first horizontal line of the spatial balance data and the second horizontal line of the spatial balance data as compared with the total height of the face;
(g) determining the relative height of the middle zone between the second horizontal line of the spatial balance data and the third horizontal line of the spatial balance data as compared with the total height of the face;
(h) determining the relative height of the bottom zone between the third horizontal line of the spatial balance data and the fourth horizontal line of the spatial balance data as compared with the total height of the face;
(i) advising the person to direct hair away from a zone if the relative height is less than about 30%; and
(j) advising the person to direct hair toward a zone if the relative height is greater than about 36%.

9. The method of claim 1 wherein determining the feature balance data comprises:
(a) positioning a first vertical line of the feature balance data over the working image at the location of the outer corner of the left eye;
(b) positioning a second vertical line of the feature balance data over the working image at the location of the inner corner of the left eye;
(c) positioning a third vertical line of the feature balance data over the working image at the location of the inner corner of the right eye;
(d) positioning a fourth vertical line of the feature balance data over the working image at the location of the outer corner of the right eye;
(e) measuring the width of the left eye between the first and second vertical lines of the feature balance data;
(f) measuring the width of the right eye between the third and fourth vertical lines of the feature balance data;
(g) determining the average of the widths of the left and right eyes;
(h) measuring the width of the space between the eyes between the second and third vertical lines of the feature balance data;
(i) comparing the average of the widths of the left and right eyes with the width of the space between the eyes;
(j) determining the eyes to be balanced if the average of the widths of the left and right eyes and the width of the space between the eyes are within about 4%;
(k) determining the eyes to be close-set if the average of the widths of the left and right eyes is more than about 4% greater than the width of the space between the eyes;
(l) determining the eyes to be wide-set if the average of the widths of the left and right eyes is more than about 4% less than the width of the space between the eyes;
(m) advising the person to direct hair away from close-set eyes;
(n) advising the person to direct hair toward wide-set eyes;
(o) advising the person to apply light shades of eye makeup to the outer one-third of the eyelid of close set eyes; and
(p) advising the person to apply dark shades of eye makeup to the outer one-third of the eyelid of wide-set eyes.

10. The method of claim 9 wherein determining the feature balance data comprises:
(a) positioning a first ray over the working image from a first anchor point located at the outside left nostril and through a first reference point located at the inside corner of the left eye;
(b) positioning a second ray over the working image from the first anchor point located at the outside left nostril and through a second reference point located at the outside corner of the left eye;
(c) positioning a third ray over the working image from a second anchor point located at the outside right nostril and through a third reference point located at the inside corner of the right eye;
(d) positioning a fourth ray over the working image from the second anchor point located at the outside right nostril and through a fourth reference point located at the outside corner of the right eye;
(e) advising the person to adjust left eyebrow length to match the space defined between the first and second rays; and
(f) advising the person to adjust right eyebrow length to match the space defined between the third and fourth rays.

11. The method of claim 10 wherein determining the feature balance data comprises:
(a) positioning a horizontal line over the working image at the level of the bottom edge of the lower-sitting ear lobe; and
(b) advising the person that hair growth is usually thicker on the side of the head having the lower-sitting ear.

12. The method of claim 1 wherein determining the natural hair growth pattern comprises:
(a) recording the location and direction of the person's whorls and cowlicks on a generic illustration of the human scalp;
(b) advising the person to comb hair in the same direction as a whorl to achieve a smooth hair appearance;
(c) advising the person to comb hair in the opposite direction as a whorl to achieve a voluminous hair appearance;
(d) advising the person to razor cut hair from a cowlick to minimize its effect; and
(e) advising the person to lift hair at the location of a cowlick to maximize its effect.

13. The method of claim 1 wherein determining the color balance data comprises a skin tone analysis and a hair color analysis.

14. The method of claim 13 wherein the skin tone analysis comprises:
(a) presenting sequentially seven pairs of color swatch images, each pair comprising a warm hue image and a cool hue image;
(b) instructing the person to select the preferred color swatch image from each sequentially presented pair;
(c) determining the person's preference for warm or cool hues;
(d) advising the person that blue-based colors complement a cool skin tone; and
(e) advising the person that yellow-based colors complement a warm skin tone.

15. The method of claim 13 wherein the hair color analysis comprises:
(a) presenting a plurality of images of hair color swatches selected from the group consisting of level one, level two, level three, level four, level five, level six, level seven, level eight, level nine, and level ten;
(b) selecting the hair color swatch that matches the person's natural hair color;
(c) inputting the hue of the person's skin tone; and
(d) advising the person to use a hair color within two levels of the person's natural hair color to complement skin tone.

16. A method of analyzing a person's facial features to assist in selecting eyewear to complement the symmetry of the face comprising:
(a) uploading a working image of the person onto a computer;
(b) positioning a first horizontal line over the working image at the level of the hairline above the forehead;
(b) positioning a second horizontal line over the working image at the mid-level of the eyebrows;
(c) positioning a third horizontal line over the working image at the level of the bottom edge of the nostrils;
(d) positioning a fourth horizontal line over the working image at the level of the bottom edge of the chin.
(e) measuring the total height of the face between the first horizontal line and the fourth horizontal line;
(f) determining the relative height of the top zone between the first horizontal line and the second horizontal line as compared with the total height of the face;
(g) determining the relative height of the middle zone between the second horizontal line and the third horizontal line as compared with the total height of the face;
(h) determining the relative height of the bottom zone between the third horizontal line and the fourth horizontal line as compared with the total height of the face; and
(i) providing advice regarding eyewear selection if the relative height of the top zone, middle zone, or bottom zone is greater than about 36%.

17. A method of using a computer to analyze a person's facial features to assist in facial image makeover and hair styling comprising:
(a) administering a questionnaire;
(b) uploading a before image of the person onto a computer;
(c) uploading a working image of the person onto the computer;
(d) performing facial symmetry analyses;
(e) providing beauty advice to enhance the symmetrical appearance of a face; and
(f) providing a report comprising said beauty advice to the person.

18. The method of claim 17 wherein performing facial symmetry analyses comprises:
(a) determining horizontal balance data;
(b) determining spatial balance data;
(c) determining feature balance data;
(d) determining natural hair growth pattern data;
(e) determining color balance data; and
(f) determining recommended eyewear.

19. The method of claim 18 further comprising:
(a) styling the person's hair in accordance with said beauty advice;
(b) applying makeup to the person in accordance with said beauty advice;
(c) applying hair coloring to the person in accordance with said beauty advice;
(d) obtaining an after image of the person;
(e) uploading the after image of the person into the computer; and
(f) recommending beauty products to the person in accordance with said beauty advice.

20. A computer-readable medium containing instructions to configure a processor to perform the method according to claim 1.
